(19) United States
(12) Patent Application Publication
(10) Pub. No.: US 2012/0317360 A1
(43) Pub. Date: Dec. 13, 2012

(54) Cache Streaming System

(75) Inventors: Thomas Zettler, Hoehenkirchen-Siegertsbrunn (DE); Gunther Fenzl, Hoehenkirchen-Siegertsbrunn (DE); Olaf Wachendorf, Unterhaching (DE); Raimar Thudt, Taufkirchen (DE); Ritesh Banerjee, Bangalore (IN)

(73) Assignee: LANTIQ DEUTSCHLAND GMBH, Neubiberg (DE)

(21) Appl. No.: 13/472,569

(22) Filed: May 16, 2012

Related U.S. Application Data
(60) Provisional application No. 61/487,699, filed on May 18, 2011.

(30) Foreign Application Priority Data
Jun. 21, 2011 (EP) 11005034.1

(51) Int. Cl. G06F 12/08

(52) U.S. Cl. 711/122; 711/118; 711/E12.024

(57) ABSTRACT

A system, having a stream cache and a storage. The stream cache includes a stream cache controller adapted to control or mediate input data transmitted through the stream cache; and a stream cache memory. The stream cache memory is adapted to both store at least first portions of the input data, as determined by the stream cache controller, and to further output the stored first portions of the input data to a processor. The storage is adapted to receive and store second portions of the input data, as determined by the stream cache controller, and to further transmit the stored second portions of the input data for output to the processor.

### CROSS REFERENCE TO RELATED APPLICATIONS

The following application claims the benefit of U.S. Provisional Application No. 61/487,699 filed May 18, 2011 and claims priority to European Patent Application No. EP 11 00 5034, filed on Jun. 21, 2011, the contents of which applications are expressly incorporated by reference herein in their entirety.

### BACKGROUND

The utility of broadband communications has extended into virtually every segment of daily life, at work, at home, and in the public square. Further, the types of data being networked into enterprise, private, and public environments are increasingly diverse. This trend is fostered especially by networking of entertainment, computation and communication equipment which had been stand-alone solutions. Thus, the requirements for networking into virtually any setting have become increasingly complex, as data formats and standards vie for bandwidth and access into a destination environment.

### BRIEF DESCRIPTION

In a first aspect of the disclosure, a system is described having a stream cache and a storage. The stream cache includes a stream cache controller to mediate input data through the stream cache. Further, the stream cache includes a stream cache memory to store at least first portions of the input data, as determined by the stream cache controller, and to further output the stored first portions of the input data to a data processor. The storage is adapted to receive second portions of the input data, as determined by the stream cache controller. An effect of the first aspect may be a reduction in processing time with respect to a conventional system that submits all input data to data processing. An effect of the first aspect may be a reduction of power consumption with respect to a conventional system that sends all input data to memory. In an aspect of the disclosure, the storage is adapted to store the second portions of the input data. In a particular aspect of the disclosure, the storage is adapted to further transmit the second portions of the input data to the stream cache memory. In particular, in an aspect of the disclosure, the stream cache memory is adapted to output to the data processor the second portions of the input data transmitted from the storage. An effect may be to improve on allocation of processing tasks to processing time, in particular, to improve a sequence of processing portions of input data dependent on whether first or second portions of the input data are to be processed.

In a further aspect of the disclosure, the system further comprises an input buffer from which the stream cache receives the input data.

In a further aspect of the disclosure, the stream cache controller is to mediate the input data streaming through the stream cache based on formatting of the input data. An effect may be to enable, on average, transmission of certain portions of input data in one format, for example in a header format, to the data processor sooner than other portions of input data in a second format, for example in a payload format.

In a still further aspect of the disclosure, the stream cache controller is to mediate the input data streaming through the stream cache based on priority of a stream of the input data. An effect may be to enable, on average, transmission of certain portions of input data with one priority, for example with a high priority, to the data processor sooner than other portions of input data with a second priority, for example with a low priority.

In a further aspect of the disclosure, the stream cache controller is to mediate the input data streaming through the stream cache by storing pointers of the portions of the input data stored on the stream cache memory and determining to store the other portions of the input data on the storage. In a particular aspect of the disclosure, the portions of the input data stored on the stream cache memory are data packet headers and the other portions of the input data stored on the storage are data packet bodies. An effect may be to enable, on average, transmission of packet headers to the data processor sooner than packet bodies. Further, in a particular aspect of the disclosure, the system further comprises a merger unit to merge the data packet headers with respective ones of the data packet bodies. An effect may be that input data may be processed faster and/or at less energy consumption than in a conventional system of similar data processing power. Processing of data packet headers of input data may involve less processing resources than processing of input data that include both data packet headers and data packet bodies. In another particular aspect of the disclosure, the first portions of the input data stored on the stream cache memory include data packets that are stored on a first-in basis and the second portions of the input data stored on the storage are data packets that are most recently received by the stream cache from the input buffer. An effect may be transmission of data packets on the first-in basis to the data processor sooner than packets in the second portions of input data.

In a further aspect of the disclosure, the storage is a level-two (L2) cache. In a further aspect of the disclosure, the storage is an external memory.

In a further aspect of the disclosure, the storage is to transmit the stored second portions of the input data to the stream cache memory on a first-in first-out basis as a time determined by the stream cache controller. An effect may be to enable processing of the first portions of the input data in accordance with a first sequence of processing, while processing the second portions of the input data in a second sequence of processing that may differ from the first sequence. For example, the second sequence of processing is a first-in first-out sequence, but the first sequence is not. In a particular aspect according to the disclosure, the storage is to transmit the stored second portions of the input data to the stream cache memory on a first-in first-out basis based on formatting thereof as instructed by the stream cache controller.

In one example, a system may include a stream cache that has a stream cache controller to mediate the input data streaming through the stream cache, and a stream cache memory to store whole or extracted portions of the input data, as determined by the stream cache controller. The cache memory, via the cache memory controller, may further output the stored portions of the input data to a data processor. The system may further include a storage to receive and store other whole or extracted portions of the input data, as determined by the stream cache controller, and further transmit the stored remaining portions of the input data to the stream cache memory for output to the data processor.

In a further aspect of the disclosure, a computer-readable medium is encompassed by the description. The computer-readable medium stores instructions thereon that, when executed, cause one or more processors to: determine first portions of an input data stream to be stored locally on a cache memory and second portions of the input data stream to be stored on a different storage; store pointers to the first portions of the input data stream that are stored locally on the cache memory; monitor the cache memory as the stored first portions of the input data stream are output to a data processing engine; and fetch the second portions of the input data stream that are stored on the different storage based on a specified criterion. An effect of the aspect of the disclosure may be a reduction of power consumption with respect to a conventional system that sends all input data to memory. An effect may also be to improve on allocation of processing tasks to processing time, in particular, to improve a sequence of processing portions of input data dependent on whether first or second portions of the input data are to be processed.

In an aspect according to the disclosure, the one or more instructions that, when executed, cause the one or more processors to determine include determining to store data packets on the cache memory on a first-in basis and to store data packets on the different storage when the cache memory is at capacity. An effect may be to avoid loading the one or more processors indiscriminately with tasks related to input data on a first-in basis, while the one or more processors operate at a limit.

In a further aspect according to the disclosure, the one or more instructions that, when executed, cause the one or more processors to determine include determining to store first level priority data packets on the cache memory and to store second level priority data packets on the different storage.

In a still further aspect according to the disclosure, the one or more instructions that, when executed, cause the one or more processors to fetch include fetching the portions of the data stream that are stored on the different storage to the cache memory as the portions of the input data stream stored on the cache memory are output to the data processing engine. In a particular aspect of the disclosure, the one or more instructions that, when executed, cause the one or more processors to fetch include fetching the portions of the data stream that are stored on the different storage to the cache memory on a first-in first-out basis.

In a further aspect of the disclosure, the one or more instructions that, when executed, cause the one or more processors to determine include determining to store data packet headers on the cache memory and to store corresponding data packet bodies on the different storage. In a particular aspect of the disclosure, the one or more instructions that, when executed, cause the one or more processors to fetch include merging the data packet headers with the corresponding data packet bodies after the respective data packet headers have been processed by the data processing engine.

In an aspect of the disclosure, the different storage is either of a level-two cache or an external memory.

The foregoing summary is illustrative only and is not intended to be in any way limiting. In addition to the illustrative aspects and features described above, further aspects and features will become apparent by reference to the drawings and the following detailed description. In particular, the foregoing and other features of this disclosure will become more fully apparent from the following description and appended claims, taken in conjunction with the accompanying drawings. Understanding that these drawings depict plural implementations and aspects in accordance with the disclosure and are, therefore, not to be considered limiting of its scope.

### SUMMARY OF THE DRAWINGS

The disclosure will be described with additional specificity and detail through use of the accompanying drawings, in which:

FIG. 1 is an illustration of a home gateway system;

FIGS. 2a-c are examples of respective implementations of a cache streaming system;

FIG. 3 is an example of a processing flow in accordance with at least one implementation of a cache streaming system;

FIG. 4 shows an example computing environment by which one or more implementations of a cache streaming system may be implemented;

FIG. 5a is a graph illustrating data rates for system input (Rin) and output (Rout) in connection with an implementation of a cache streaming system;

FIG. 5b is a graph illustrating power as a function of data rate (Rin) in connection with an implementation of a cache streaming system; and

FIGS. 6a-e show respective implementations of a cache streaming system according to respective aspects of the disclosure.

### DETAILED DESCRIPTION

In the following detailed description, reference is made to the accompanying drawings, which form a part of the description. Unless otherwise noted, the description of successive drawings may reference features from one or more of the previous drawings to provide clearer context and a more substantive explanation of the exemplary disclosure. Still, the exemplary disclosure described in the detailed description and drawings are not meant to be limiting. Other aspects may be utilized, or changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

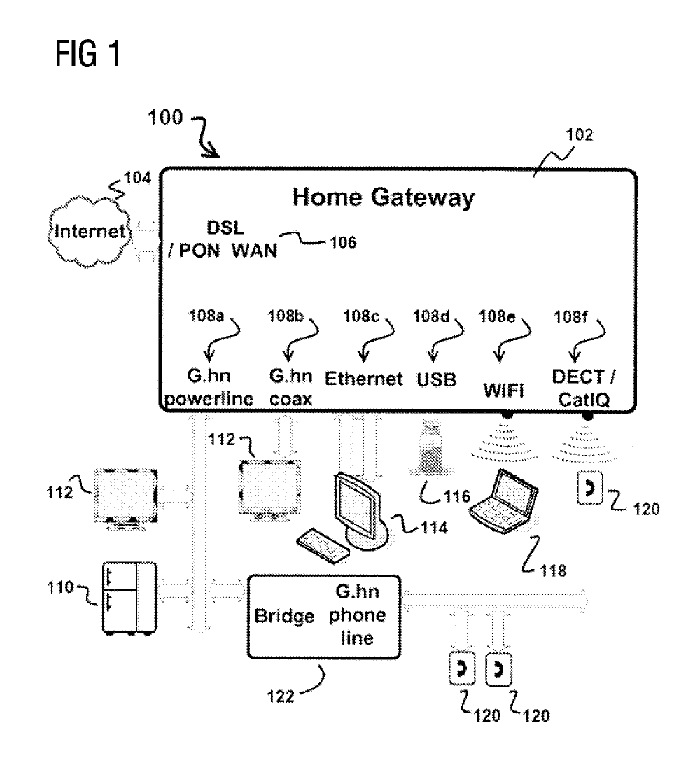

FIG. 1 shows a home gateway system 100 with data connections of multiple different standards. In particular, home gateway 102 is shown connected to the Internet 104 via an interface including a DSL (digital subscriber line), PON (passive optical network), or through a WAN (wide-area network). Likewise, the home gateway is connected via a diverse set of standards 108a-f to multiple devices in the “home”. For example, home gateway 102 may communicate according to the International Telecommunication Union's ‘G.hn’ home network standard, for example over a power line 108a to appliances such as refrigerator 110 or television 112. Likewise, G.hn connections may be established by coaxial cable 108b to television 112.

Communication with home gateway 102 over Ethernet 108c, universal serial bus (USB) 108d, WiFi (wireless LAN) 108e, or digital enhanced cordless telephone (DECT) 108f can also be established, such as with computer 114, USB device 116, wireless-enabled laptop 118 or wireless telephone handset 120, respectively. Alternatively, or in addition, bridge 122, connected for example to home gateway 102 via G.hn powerline connection 108a may provide G.hn telephone access interfacing for additional telephone handsets 120. It should be noted however, that the present disclosure is not limited to home gateways, but is applicable for all data stream processing devices.

Home gateways such as home gateway 102 may serve to mediate and translate the data traffic between the different formats of standard interfaces, including exemplary interfaces 108. Modern data communication devices like home gateway 102 often contain multiple processors and hardware accelerators which are integrated in a so-called system on chip (SOC) together with other functional building blocks. The processing and translation of the above mentioned communication streams require a high computational performance and bandwidth of the SOC architecture. Typically, two exemplary approaches can be applied toward this requirement. First, a processor (load store) with cache memory or second, a hardware accelerator.

In the first solution, the general purpose processor working with a limited set of registers and potentially a local cache memory is a flexible solution which can be adapted by software to multiple tasks. The performance of the processor is however limited and power consumption per task relatively high compared with a dedicated hardware solution.

By contrast, a hardware accelerator is a hardware element design of a narrow defined task. It may even exhibit a small level of programmability but is in general not sufficiently flexible to be adapted to other tasks. For the predefined task, the hardware accelerator shows a high performance compared with a load store on a fixed operating frequency. Another benefit is low power consumption resulting in a low energy per task figure.

In an aspect of this disclosure, provision of high-performance data stream processing systems are achieved, for example, by a processor and/or hardware accelerator in conjunction with an element referred to herein as ‘stream cache’ (memory). The data stream is directly written into the stream cache by interface hardware and/or direct memory access. The stream cache is one aspect of the disclosure and the functionality of the stream cache will become apparent by reference to the appended figures, and the description herein.

Optionally, the stream cache is held coherent with other caches. This is to allow multiple processors and/or hardware accelerators access to the data content of the stream cache. Optionally, cache-to-cache transfer is possible. This allows the coherent processor to fetch data out of the stream cache into local cache without moving the data to an external memory. The proximity of local cache aids in the speed of data transfer, in addition to other benefits, including reduced power consumption. Increased architecture flexibility is also foreseen.

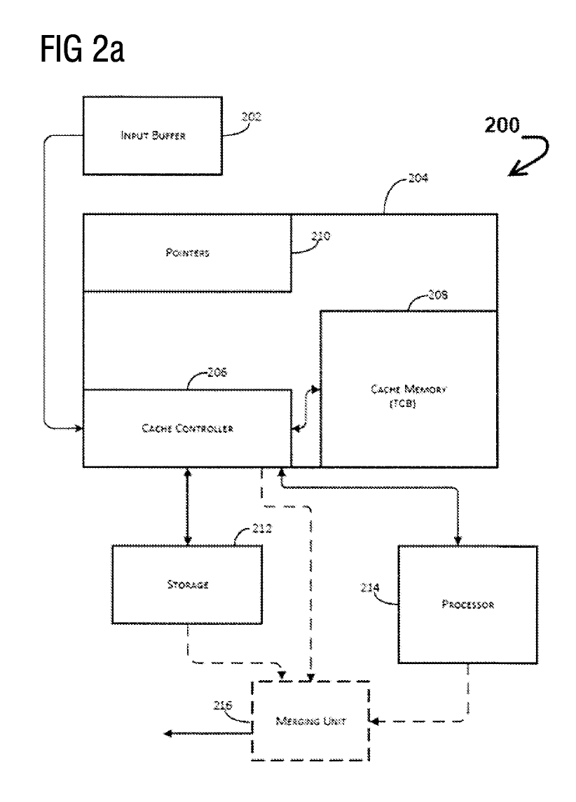

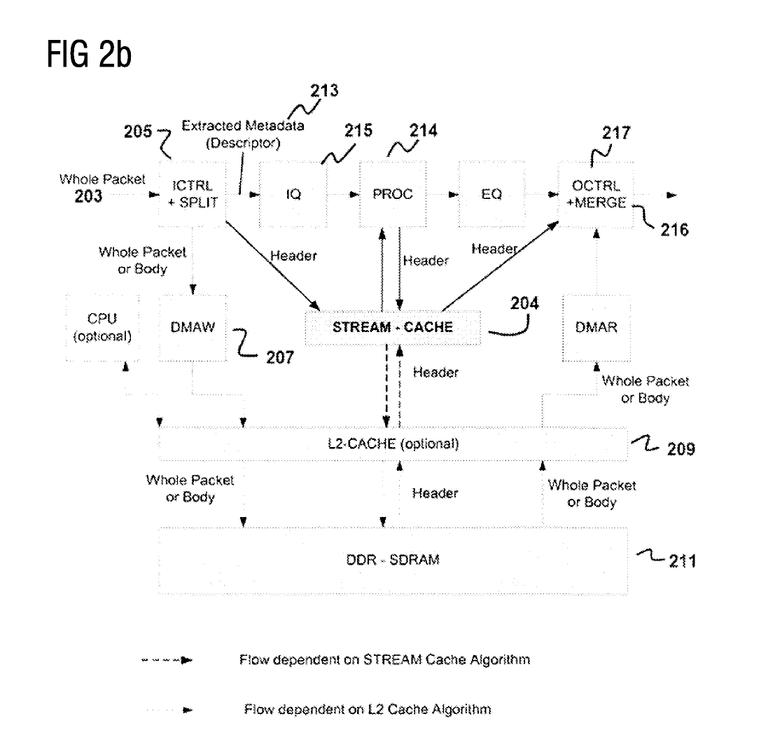

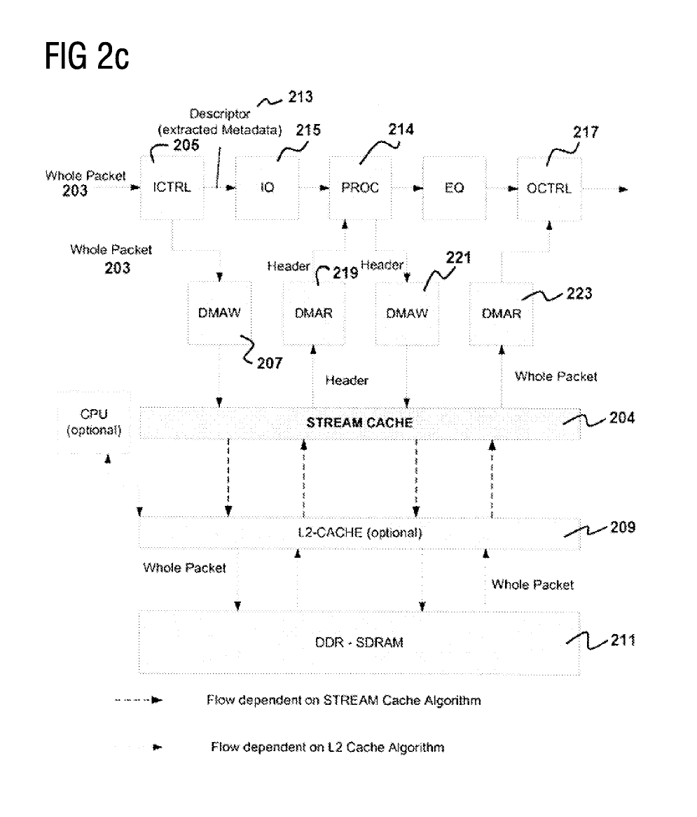

FIG. 2a shows an example implementation of a cache streaming system 200, which may alternately be referred to herein as “system 200.” In addition to cache unit 204, which includes at least cache controller 206, cache memory, or “tightly coupled buffer” (TCB) 208, and pointers storage 210, one or more implementations of system 200 may include input buffer 202, storage 212, processor 214, and merging unit 216.

Input buffer 202 may receive a stream of data packets from a data source, e.g., via from an interface hardware or by direct memory access (DMA) from another cache, and input the stream of data to cache unit 204. In at least one implementation, input buffer 202 may split data packets received as part of the stream of data into headers and respective payloads, i.e., bodies. Processing of the separated headers and payloads are described below in the context of one or more implementations of system 200.

Cache unit 204, alternatively referred to herein as “stream cache 204,” may be implemented as hardware, software, firmware, or any combination thereof. More particularly, cache 204 may be a cache that is coherent with other caches to allow multiple processors and other devices, e.g., accelerators, to access content stored therein. Stream cache unit 204 may further facilitate cache-to-cache transfer to allow a coherent processor to fetch data therefrom without requiring the data to be transferred to an external memory. The fetched data, as described below, may include data packets or data packet headers and/or data packet payloads.

Cache controller 206 may also be implemented as hardware, software, firmware, or any combination thereof to mediate the input data packets streaming through cache unit 204. More particularly, cache controller 206 may determine to store a configured portion of the input data stream to cache memory 206 and another portion to at least one configuration of storage 212.

The originally filed Figures support an illustration that the storage 212 in one aspect may be physically separate from the cache memory 206, and in another aspect from the cache unit 204.

As described herein, cache controller 206 may determine to store, fetch, or retrieve data packets or portions thereof to various destinations. Thus, to “determine,” as disclosed herein, may include cache controller 206 or another controller or component of system 200 routing or causing one or more data packets to be routed to a destination, either directly or by an intervening component or feature of system 200. Such example destinations may include cache memory 208, storage 212, processor 214, and merging unit 216.

In at least one aspect of the disclosure, cache controller 206 may determine to store intact data packets, both header and payload, into cache memory 208 until storage capacity of cache memory 208 is at its limit. That is, cache controller 206 may determine to store data packets to cache memory 208 on a first-in basis. Accordingly, when the storage capacity of cache memory 208 is at its limit, cache controller 206 may determine to store the most recently input data packets to at least one implementation of storage 212. That is, cache controller 206 may determine to store data packets to at least one implementation of storage 212 on a last-in (to cache unit 204) basis.

In a further aspect of the disclosure, when input buffer 202 splits data packets received as part of the stream of data into headers and respective payloads, i.e., bodies, cache controller 206 may determine to store the data packet headers to cache memory 208 and corresponding data packet payloads to at least one implementation of storage 212.

In a further aspect of the disclosure, exclusive to or in combination with the other aspects or implementations described herein, cache controller 206 may determine to store intact data packets or data packet headers to cache memory 208 based on priority of the data stream in which the data packets are routed to cache 204 from input buffer 202. The priority of the data streams may depend, for example, upon a format of the respective data streams. Thus, in the context of a network gateway at which data streams, including multimedia data streams, are competing for bandwidth, priority may be given, e.g., to voice data packets over video data packets. Document file data that does not have any real time requirements may be an example of low priority data, according to this aspect of the disclosure. In other words, cache controller 206 may determine to storage intact data packets or data packet headers in cache memory 208 depending upon a currently run application. Accordingly, as in the aforementioned example, cache controller 206 may determine to store voice data packets, entirely or portions thereof, to cache memory 208 while video data packets, entirely or portions thereof, may be stored to at least one implementation of storage 212 until all of the voice data packets are routed to processor 214.

By at least any of the aspects described above by which cache controller 206 may determine to store data packets, either entirely or portions thereof, to at least one implementation of storage 212, cache controller 206 may further monitor cache memory 208 as data packets, either in their entirety or just headers thereof, are fetched to processor 214 for processing. Thus, as storage capacity becomes available in cache memory 208, cache controller 206 may fetch data, either intact packets or data packet payloads, on a first-in first-out basis or on a priority basis based on, e.g., formats of the respective data streams.

Cache memory 208 may also be implemented as hardware, software, firmware, or any combination thereof to at least store portions of the input data streams, as determined by cache controller 106, and to further output the stored data back to cache controller 206.

Pointer storage 210 may also be implemented as hardware, software, firmware, or any combination thereof to at least store physical or virtual addresses of data, either intact data packets or portions thereof, stored to cache memory 108 and implementations of storage 212. Accordingly, cache controller 206 may reference data, either data packets or payloads, for fetching from the utilized implementations of storage 212 by utilizing pointers stored on pointer storage 210.

Storage 212 may also be implemented as hardware, software, firmware, or any combination thereof to store at least a configured portion of the input data stream as determined by cache controller 206.

By at least one aspect, cache controller 206 may determine to store intact data packets, both header and payload, to cache memory 208 on a first-in basis, so when the storage capacity of cache memory 208 is at its limit, cache controller 206 may determine to store the most recently input data packets to at least one implementation of storage 212 on a last-in (to cache unit 204) basis.

By at least one other aspect, when input buffer 202 splits data packets received as part of the stream of data into headers and respective payloads, cache controller 206 may determine to store the data packet headers to cache memory 208 and corresponding data packet payloads to at least one implementation of storage 212.

By at least another aspect, cache controller 206 may determine to store intact data packets or data packet headers to cache memory 208 based on priority, so that cache memory 208 may store top level data packets or data packet headers and storage 212 may store secondary level priority data packets or data packet headers.

Aspects of storage 212 as set forth in the description may include an L2 (Level-2) cache, which is a memory that may advantageously on the same chip as cache 204, packaged within the same module. As set forth above, storage 212 as an L2 cache may feed into cache memory 208, which may be an L1 cache, which feeds processor 214. To the extent that cache streaming system 200 includes an L2 cache, cache streaming system 200 may be implemented as a system-on-a-chip (SOC) solution, i.e., having all features sitting on a common circuit chip.

Further aspects of storage 212 may include an external RAM (Random Access Memory) or an external HDD (hard disk drive), alternatively or in combination with an L2-cache. As a RAM, example implementations of storage 212 may include an SDRAM (Synchronous Dynamic RAM) or PRAM (Phase Change Memory).

FIG. 2b discloses an exemplary configuration of stream cache implementation. In particular, the stream cache unit 204 provides efficient storage for data processing engine 214 (PROC). The incoming data stream 203 may be handled by the ingress control block 205 (ICTRL) which includes splitter unit SPLIT, which may split the data as described herein. Writing data by DMA 207 (DMAW) may include the body or entire data packet to L2 cache 209 or to the DDR-SDRAM 211. The header, such as extracted by SPLIT may be stored in stream cache unit 204. To the extent that a reduced data set, such as only the headers of one or more packets 203 is stored, the size of stream cache 204 may be kept small, increasing efficiency. The processing engine (e.g. PROC 214), including CPUs or hardware accelerators, are shown receiving metadata (descriptor) 213 extracted by ICTRL 205 via an ingress queue unit 215 (IQ). PROC 214 typically fetches and processes headers from stream cache unit 204 and writes back processed headers to stream cache 204. The new headers may be merged with the packet bodies in merge unit 217 (MERGE).

FIG. 2c discloses another exemplary configuration of a stream cache implementation. Incoming data stream 203 is handled by ingress control block 205 (ICTRL). Write DMA 207 (DMAW) writes whole packet 203 to L2 cache 209 or to the DDR SDRAM 211. In this sense, the implementation of FIG. 2c differs to that of FIG. 2b, in that here the whole packet 203 is stored to the stream cache unit 204. Although larger memories are required to accommodate this aspect, the merging of headers and bodies to new packets may be simplified since a dedicated merger unit is avoided in output control block 217 (OCTRL).

Processing engine (e.g. PROC 214), including CPUs or hardware accelerators, receive metadata 213 extracted by ICTRL 205 via an ingress queue unit 215 (IQ). First read DMA controller 219 (DMAR) fetches headers from stream cache 204 to PROC 214 and second DMA write 221 (DMAW) writes back processed headers to stream cache unit 204. The second read DMA 223 (DMAR) writes the new packet to the output control block 217 (OCTRL).

Regardless of its implementation as an L2-cache or RAM, storage 212 (FIG. 2a) is to store data packets or data packet payloads in such a manner that, upon fetching by cache controller 206 on either a first-in first-out basis or on a priority basis, there is no delay caused for processor 214.

Processor 214 may also be implemented as hardware, software, firmware, or any combination thereof to at least process data from cache memory 208. The data from cache memory 208 may include data packets or data packet headers from the data stream input to cache unit 204 from input buffer 202.

In accordance with the one or more aspects by which input buffer 202 splits received data packets into headers and respective payloads and cache controller 206 may determine to store the data packet headers in cache memory 208, processor 214 may process the headers apart from the respective payloads. Upon processing one or more data packet headers, processor 214 may return the one or more processed data packet headers to cache controller 206 or forward the one or more processed data packet headers to merging unit 216.

Merging unit 216 is an optional component of system 200 that may also be implemented as hardware, software, firmware, or any combination thereof to merge data packet headers that have been processed by processor 214 with respectively corresponding data packet payloads.

As stated above, upon processing one or more data packet headers, processor 214 may return the one or more processed data packet headers to cache controller 206. By this example scenario, cache controller 206 may then forward the one or more processed data packet headers to merging unit 216. Further, cache controller 206 may further cause storage 212 to forward to merging unit 216 the data packet payloads corresponding to the one or more processed data packet headers. Alternatively, particularly when storage 212 is embodied as a RAM, a controller (not shown) for storage 212 may cause storage 212 to forward the data packet payloads corresponding to the one or more processed data packet headers to merging unit 216.

Data processed by processor 214 may be forwarded to its destination from processors 214 or from merging unit 216.

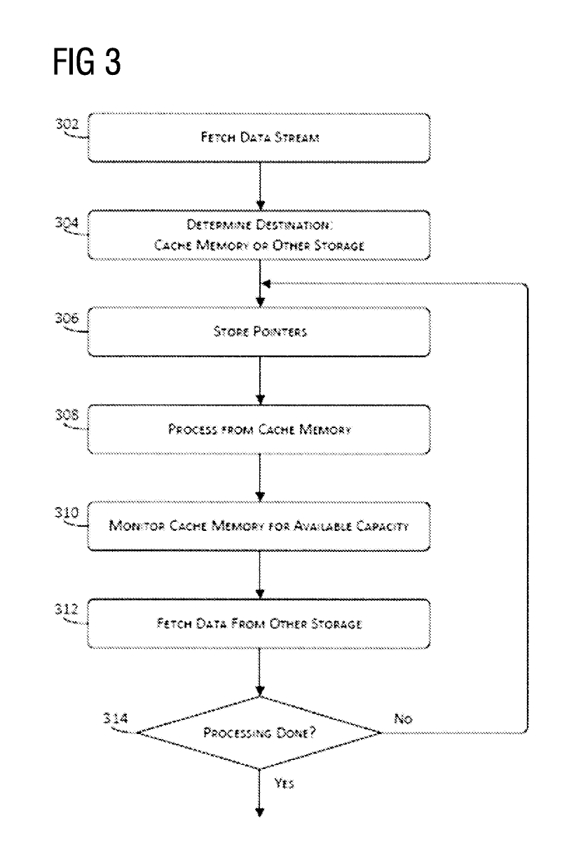

FIG. 3 shows an example processing flow 300 in accordance with at least one aspect of a cache streaming system. More particularly, processing flow 300 is described herein with reference to the example system 200 described above with reference to FIGS. 2a-c. However, processing flow 300 is not limited to such example configuration, and therefore the present description is not intended to be limiting in any such manner. Further, example processing flow 300 may include one or more operations, actions, or functions as illustrated by one or more of blocks 302, 304, 306, 308, 310, 312, and/or 314. Although illustrated as discrete blocks, various blocks may be divided into additional blocks, combined into fewer blocks, or even eliminated, depending on a desired implementation. Moreover, the blocks in the FIG. 3 may be operations that may be implemented by hardware, software, or a combination thereof associated with measurement cache system 200. Processing flow 300 may begin at block 302.

Block 302 may include an input data stream fetched into cache unit 204 from input buffer 202, either directly from interface hardware or by DMA from another cache. As set forth above, in at least one aspect of the disclosure, input buffer 202 may split data packets received as part of the stream of data into headers and respective payloads. Processing flow 300 may proceed to block 304.

Block 304 may include cache controller 206 determining a destination for intact or portions of data packets included in the input data stream. That is, cache controller 206 may determine to store a configured portion of the input data stream to cache memory 206 and another portion to at least one implementation of storage 212.

Again, to “determine,” as disclosed herein, may include cache controller 206 or another controller or feature of system 200 routing or causing one or more data packets to be routed to a destination, either directly or by an intervening component or feature of system 200

By at least one aspect of the present disclosure, cache controller 206 may determine to store intact data packets, both header and payload, to cache memory 208 until cache memory 208 is full on a first-in basis. Then, cache controller 206 may determine to store the most recently input data packets to at least one implementation of storage 212 on a last-in (to cache unit 204) basis.

By at least one other aspect, when input buffer 202 splits data packets received as part of the stream of data into headers and respective payloads, cache controller 206 may determine to store the data packet headers to cache memory 108 and corresponding data packet payloads to at least one implementation of storage 212.

By at least another aspect, exclusive to or in combination with the other aspects of the disclosure described herein, cache controller 206 may determine to store intact data packets or data packet headers to cache memory 208 based on priority of the data stream in which the data packets are routed to cache unit 204 from input buffer 202. That is, cache controller 206 may determine to storage intact data packets or data packet headers to cache memory 208 depending upon a currently run application.

As set forth above, the input data stream may be fetched into cache unit 204 from input buffer 202, either directly from interface hardware or by direct memory access from another cache. Thus, in accordance with at least one other aspect of the disclosure, a controller associated with the interface hardware or the other cache may determine to write the intact data packets or data packet headers to either of cache unit 204 or an implementation of storage 212. Processing flow 300 may proceed to block 306.

Block 306 may include cache controller 206 determining to store to pointer storage 210 the physical or virtual addresses of data, either intact data packets or portions thereof, stored to cache memory 208 and implementations of storage 212. Processing flow 300 may proceed to block 308.

Block 308 may include processor 214 process data from cache memory 208. The data from cache memory 208 may include data packets or data packet headers from the data stream input to cache unit 204 from input buffer 202. As set forth previously, in accordance with the one or more aspects of the disclosure, processor 214 may process the headers apart from the respective payloads. Thus, block 308 may further include processor 214 returning the one or more processed data packet headers to cache controller 206 or forwarding the one or more processed data packet headers to merging unit 216. Processing flow 300 may proceed to block 310.

Block 310 may include cache controller 206 monitoring cache memory 208 as data packets, either in their entirety or just headers thereof, are fetched back from cache memory 108 and then to processor 214 for processing. Processing flow 300 may proceed to block 312.

Block 312 may include cache controller 206, as capacity in cache memory 208 becomes available, fetching data, either intact packets or data packet payloads, on a first-in first-out basis or on a priority basis. Processing flow 300 may proceed to decision block 314.

Decision block 314 may include cache controller 206 determining whether all data packets or data packet headers associated with an input data stream have been processed. More particularly, as cache controller 206 monitors cache memory 208, a determination may be made as to whether all of an input data stream has been processed.

If the decision at decision block 314 is “no,” processing flow returns to block 306.

If the decision at decision block 314 is “yes,” processing for the input data stream has been completed.

As a result of the determinations resulting from processing flow 300, high performance data stream processing may be implemented by hardware, software, firmware, or a combination thereof.

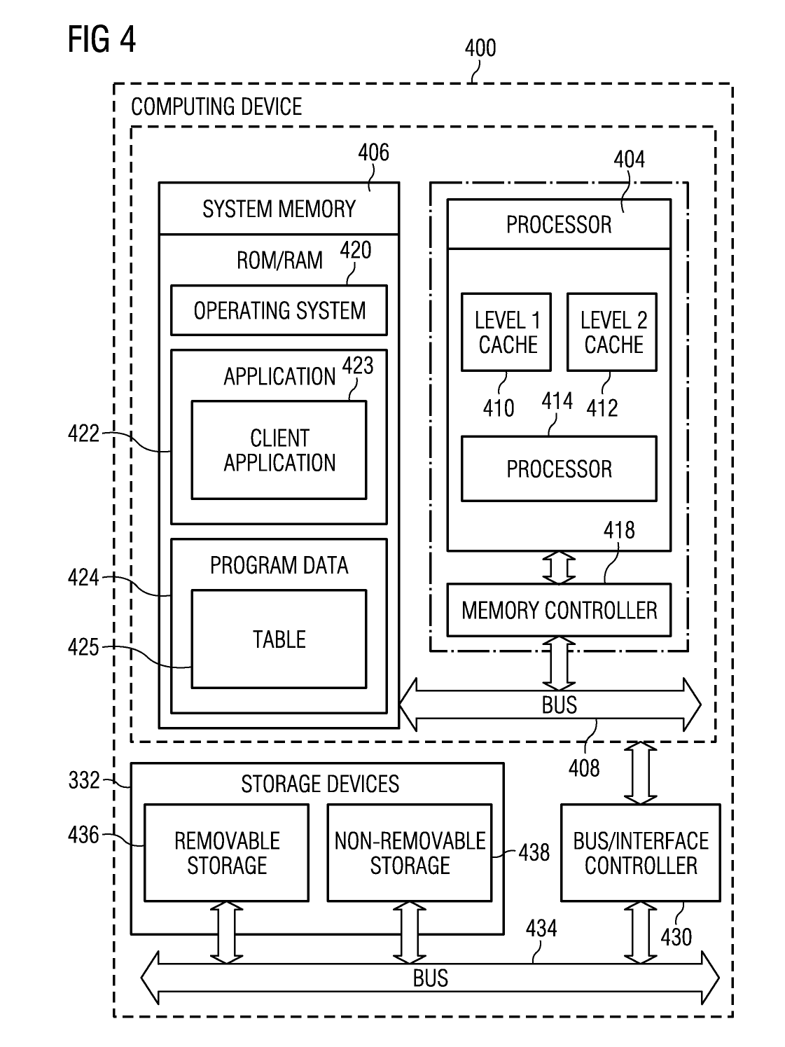

FIG. 4 shows sample computing device 400 in which various aspects of the disclosure may be implemented. More particularly, FIG. 4 shows an illustrative computing implementation, in which any of the operations, processes, etc. described herein may be implemented as computer-readable instructions stored on a computer-readable medium. The computer-readable instructions may, for example, be executed by a processor of a mobile unit, a network element, and/or any other computing device.

In an example configuration 402, computing device 400 may typically include one or more processors 404 and a system memory 406. A memory bus 408 may be used for communicating between processor 404 and system memory 406.

Depending on the desired configuration, processor 404 may be of any type including but not limited to a microprocessor, a microcontroller, a digital signal processor (DSP), or any combination thereof. Processor 404 may include one more levels of caching, such as level one cache 410 and level two cache 412, and processor core 414. Cache unit 204 may be implemented as level one cache 410 and at least one implementation of storage 212 may be implemented as level two cache 412.

An example processor core 414 may include an arithmetic logic unit (ALU), a floating point unit (FPU), a digital signal processing core (DSP Core), or any combination thereof. Processor 214 may be implemented as processor core 414. Further, example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. Storage 212 may be implemented as memory 406 in at least one aspect of system 200. System memory 406 may include an operating system 420, one or more applications 422, and program data 424.

Application 422 may include Client Application 423 that is arranged to perform the functions as described herein including those described previously with respect to FIGS. 2 and 3. Program data 424 may include Table 425, which may alternatively be referred to as “figure table 425” or “distribution table 425.”

Computing device 400 may have additional features or functionality, and additional interfaces to facilitate communications between basic configuration 402 and any required devices and interfaces. For example, bus/interface controller 430 may be used to facilitate communications between basic configuration 402 and one or more data storage devices 432 via storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436, and non-removable storage devices 438 are examples of computer storage media. Computer storage media may include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

As discussed in general above, multiple cache control mechanisms are applicable. The stream cache algorithm in accordance with an aspect of the present disclosure can take advantage of the sequential nature of the data. For example a proposed first cache algorithm is to remove the most recently entered data. When the last available cache line is to be written, the data may automatically be written to DRAM by cache controller.

A further cache algorithm in accordance with an aspect of the present disclosure is for two data streams. In particular, two data streams are set to different levels based on priority of streams and redirect new entries of the first stream when reaching a first level, and redirect new entries of the second stream when reaching a second level, respectively.

A further cache algorithm in accordance with an aspect of the present disclosure distinguishes packet header and body if both are to be stored in the stream cache (see for example FIG. 2c). Assuming that only the header is altered via processing in case of overflow, packet bodies are evicted from stream cache while keeping the headers where possible.

A further cache algorithm in accordance with an aspect of the present disclosure assigns an importance value to data packets (headers, bodies, or both) depending on the level of processing they have experienced. The importance value has to be stored in the stream cache and must be used for selection of eviction priority. This allows packets readily processed to leave the system with minimum delay without eviction and refetching, keeping the throughput high.

A further cache algorithm in accordance with an aspect of the present disclosure locks data (i.e. protect data from any eviction) which have been fetched by the processing engine(s) PROC (214). This assures that processed data can be written back quickly while avoiding that corresponding data in the stream cache being evicted during the processing in PROC.

It will be understood by a person of skill in the art that the above cache algorithms may be used alone or in combination with each other.

Dimensioning of on-chip memories in the light of only partially known software applications can present design difficulties. This results in software architectures which avoid the usage of high performance on-chip memories but instead route the data streams to off-chip memories of practically unlimited capacity. Alternatively, software architectures have to design an error prone method which dynamically changes the storage location from on-chip to off-chip if on-chip capacity limits are reached. This is also difficult, particularly when hard real time requirements have to be obeyed and important software parts (for example under linux) are unable to support hard real time.

By the introduction of a stream cache coupled processor or hardware accelerator, the problem of detecting the overflow and redirecting the traffic flow is solved and automatically performed by hardware fully transparent to software. A major advantage compared to other solutions is the improved processing performance of the system due to faster memory/stream cache access times compared to external memory access.

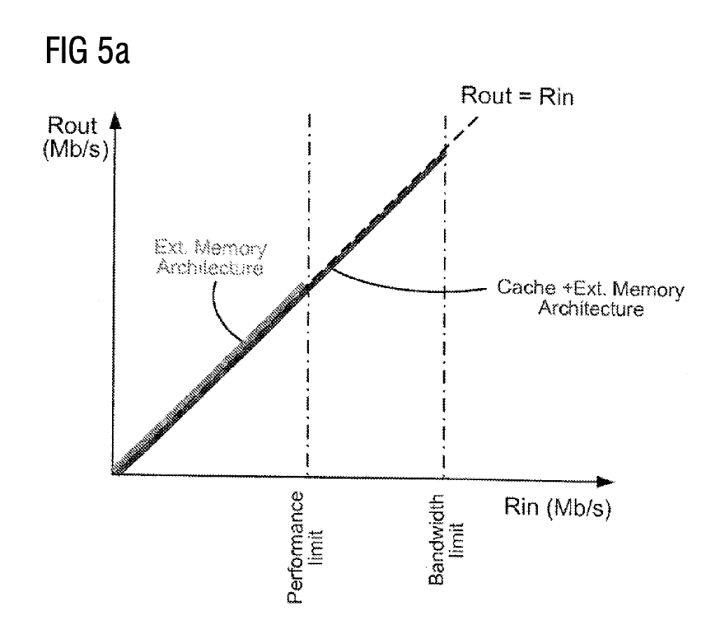

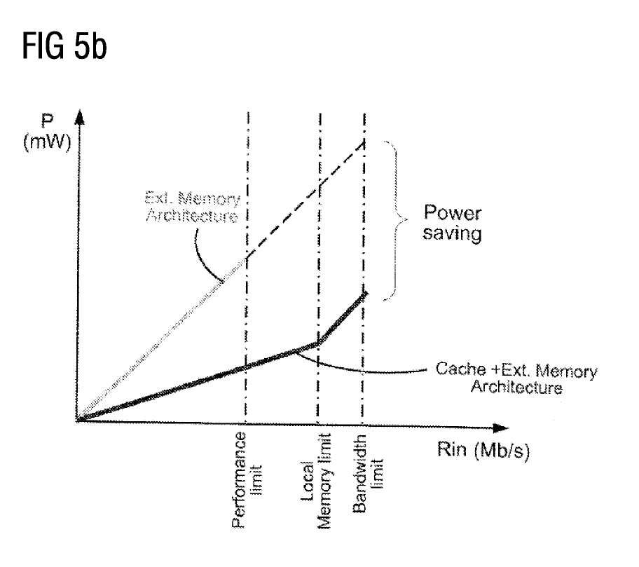

As shown in FIG. 5a the overall average data rate (shown as data rates for system input (Rin) and output (Rout)) can be improved by the stream cache plus external memory architecture given that the application throughput was performance limited by memory access before. In addition the stream cache allows to process temporary burst of data traffic exceeding the cache size.

FIG. 5a illustrates power consumption, i.e. system power (P) vs. input data rate (Rin). As shown in FIG. 5a, the performance-limited state of the art approach as well as the performance under an aspect of the presently disclosed stream caches architecture is shown. As long as the operation on data packets is purely from stream cache all overhead power needed for external memory access is saved. This is visible by the reduced slope of the Power versus traffic curve. When a local memory (stream cache) limit is reached and parts of the traffic needs to be directed to DRAM external memory, an increased power per data unit consumption is visible, in any case, however, a substantial energy per task reduction is achieved.

Optionally, as discussed herein below, the main CPU can be enriched by components like Data Scratch Pad SRAM (DSPRAM), Instruction Extension Logic and/or Coprocessors without deviating from the scope of the present disclosure. Placing these units local to the CPU may reduce the computation requirement of the main CPU. Instruction Extension Logic or Coprocessors are programmable highly optimized state machines closely coupled to the main CPU, dedicated for special recurring code sequences. DSPRAM is closely coupled memory which can be filled with data e.g. Ethernet packets to be processed by the main CPU.

Standard Accelerator Engines are implemented in a system-on-chip (SoC) implementation, taking over special tasks e.g. CRC checksum calculation, further offloading the main CPU handling the data flow. An Acceleration Engine is comprised of an optimized hardware state machine, a programmable and deeply embedded CPU, or a combination of both. Typically, these accelerators are connected to an interconnect, communicating with the main CPU via shared memory e.g. DDR SDRAM.

All of these schemes have to process the input data stream at wire speed, or else they have to solve an overload situation. In case the system is not able to keep pace, either backpressure has to be applied or the data has to be temporarily swapped to main memory e.g. DDR SDRAM. The input buffer shown in the examples may decouple the receiving part from the processing part in order to prevent the overload condition for short periods which may be undesirable in some applications. Blocking the input stream via backpressure may lead to dropping packets at the receiver side. As the packets have to be re-sent, the power consumption may be increased.

More recent schemes process the data and control the data flows by tightly coupling the Acceleration Engines to the coherent CPU cluster. Standard RISC CPU systems offered by companies like MIPS and ARM provide such coherent input ports. The received data is streamed through the Acceleration Engine into the coherent processing system. This semi coherent Engine exploits the full potential of a coherent processing system i.e. this approach is suitable for SoC with multiple CPU cores.

A Cache Coherent Accelerator Engine includes the novel stream cache, always presenting the data structure to be processed next e.g. Ethernet header to the processing unit. Note that processing unit may be a CPU, a hardware accelerator or a combination of both. Furthermore, this stream cache participates in a coherent processing system. Each CPU may access the data structure in a cached and coherent way.

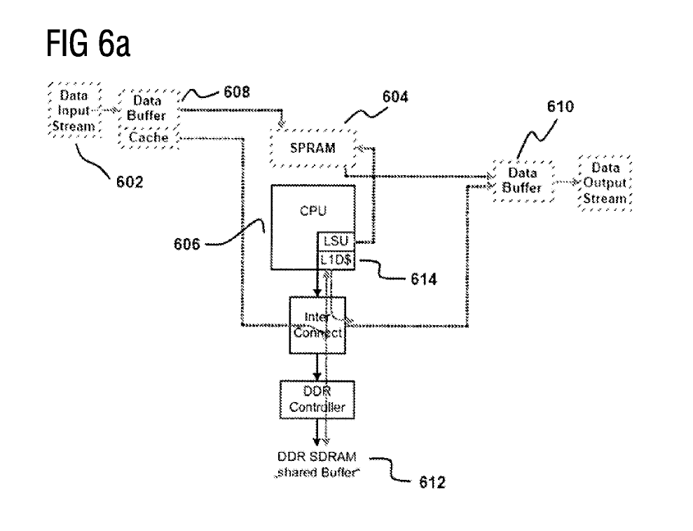

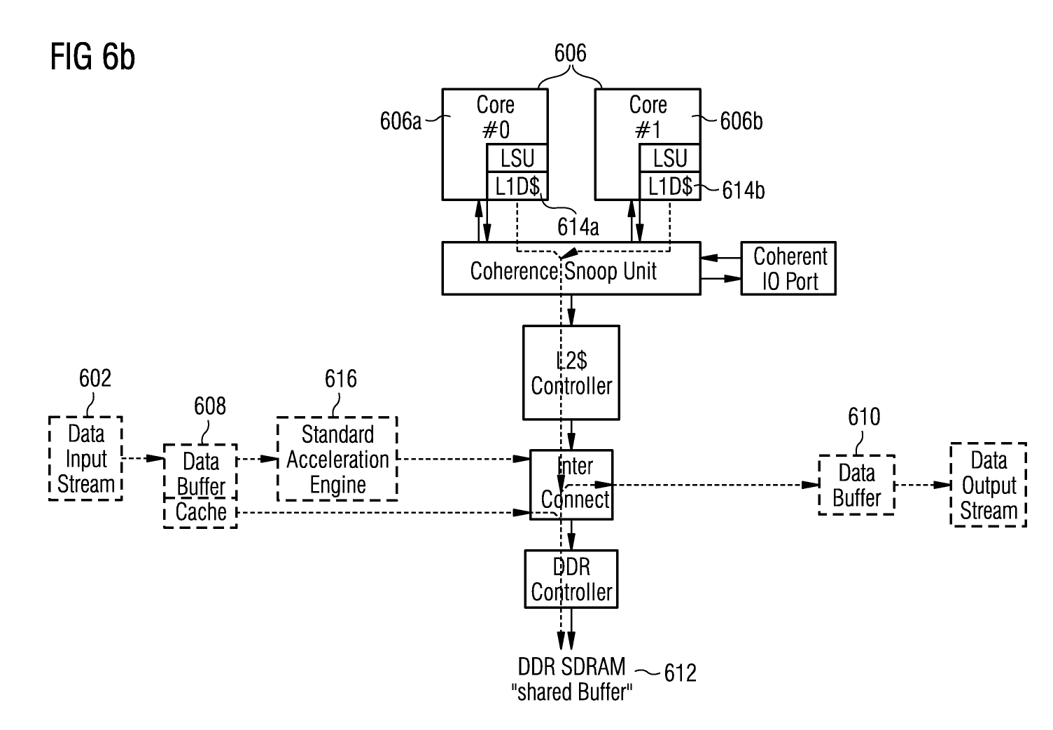

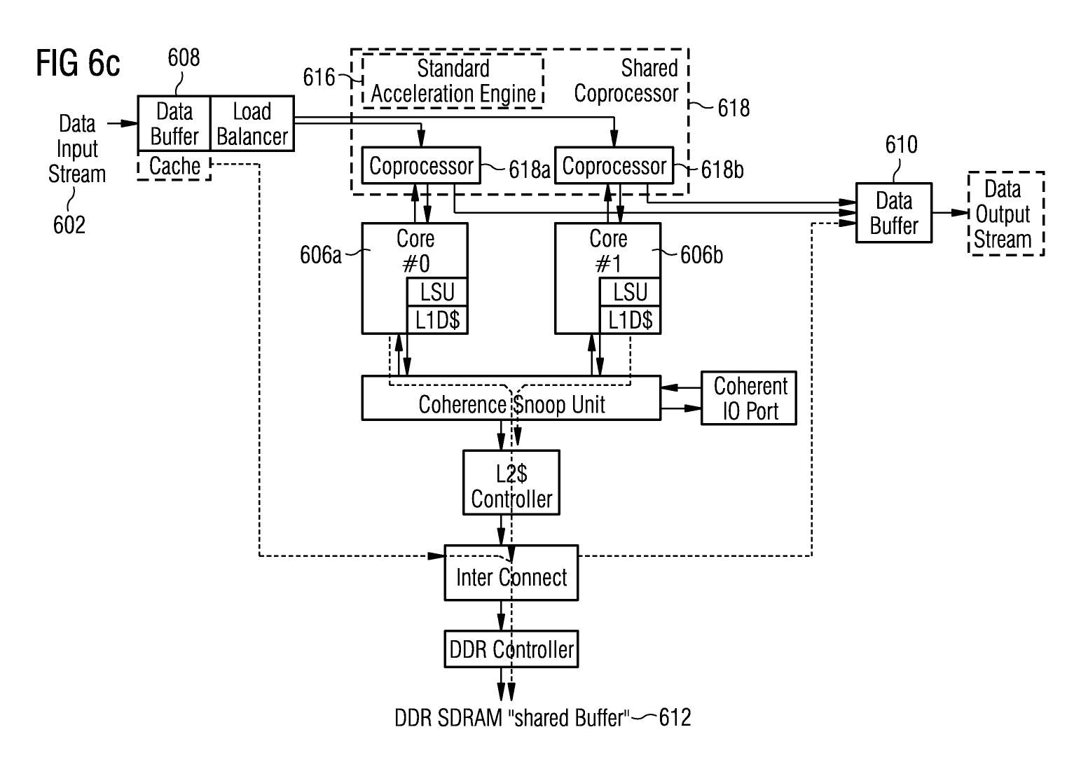

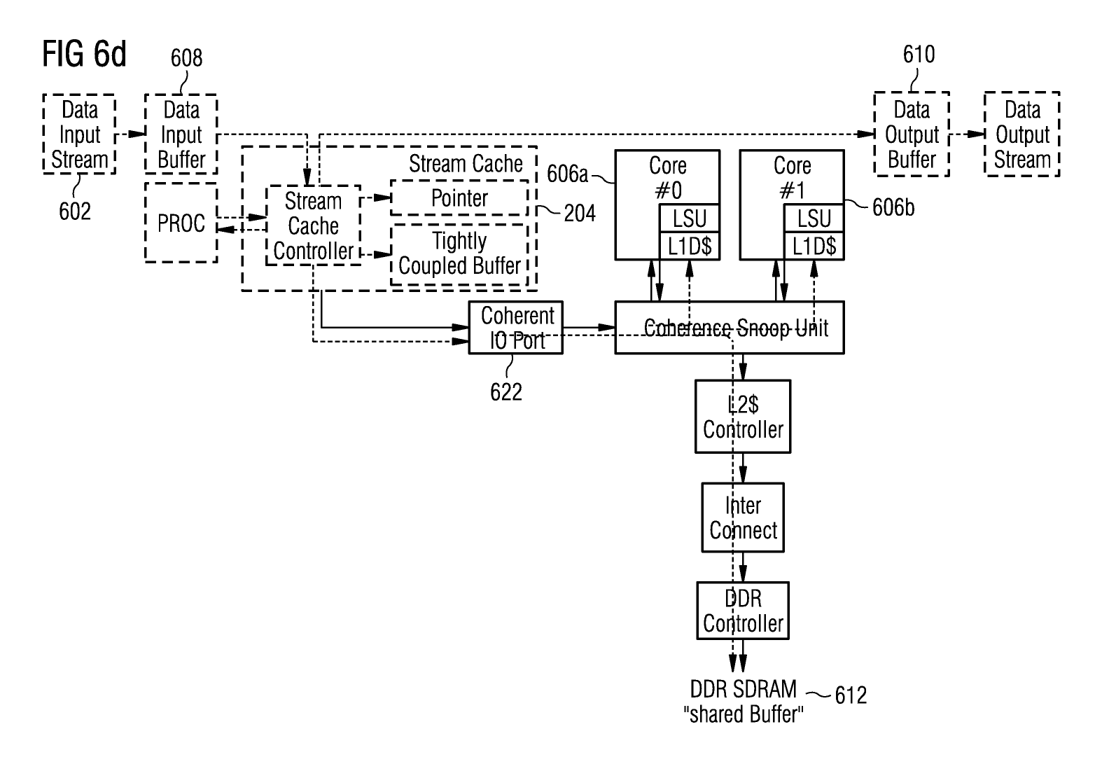

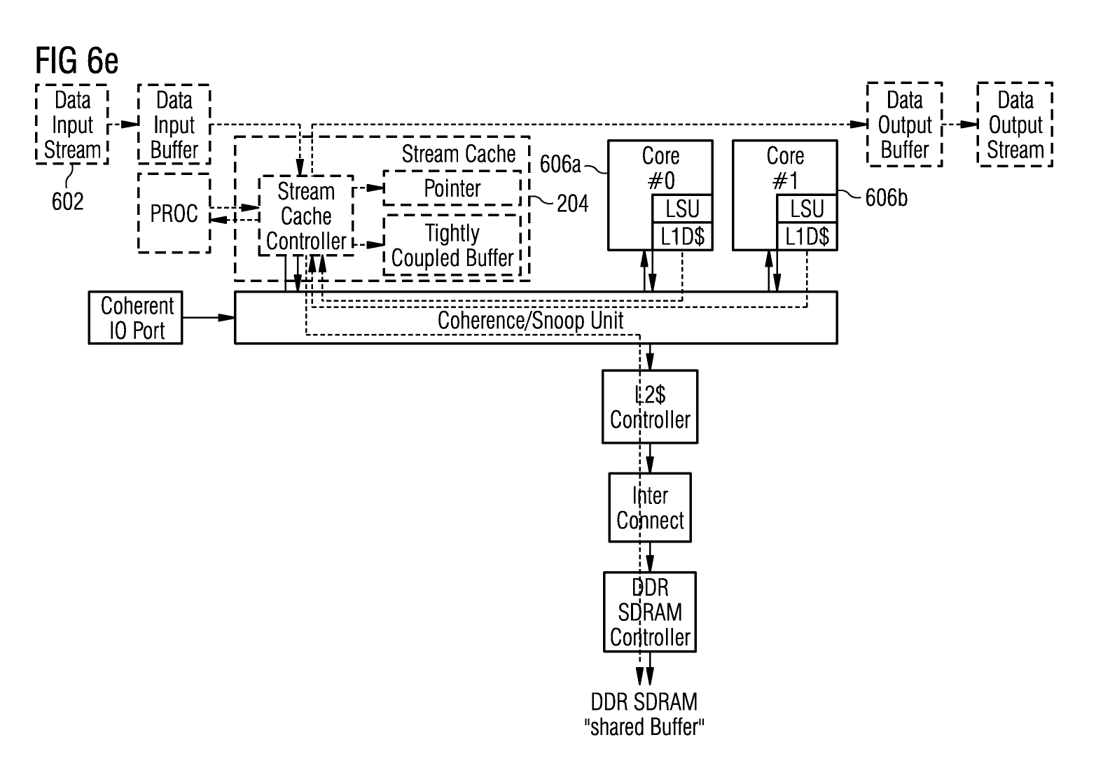

FIG. 6a shows an aspect of the disclosure configured as data scratch pad SRAM (DSPRAM). DSPRAM, also known as tightly coupled memory (TCM) is available by RISC CPU vendors such as ARM, ARC, MIPS and Tensilica. This configuration streams data 602 in SPRAM 604 which is tightly coupled to the core of CPU 606. There is no need for CPU 606 to fetch data from a main memory. Furthermore, there is a guaranteed and minimal access time from CPU 606 to the data. In case data input buffer 608 can split the received data stream into header and payload, the header will be stored in SPRAM 604 while the payload will be stored, for example in main memory. Typically CPU 606 processes the header e.g. NAT routing and reassembles the modified header and payload to be transferred to output data buffer 610. As indicated in FIG. 6a, it is possible to attach the stream cache to SPRAM 604 leading to an improved architecture capable of processing temporary bursts exceeding the capacity of cache and SPRAM.

FIG. 6b shows an aspect of the disclosure based on a standard acceleration engine 616. Standard acceleration engines typically receive and process data steam 602 at wire speed. Optionally, a stream cache can be attached to engine 616 if it cannot process the input data stream at wire speed. Engine 616 may deal with a subset of the workload in processing and controlling a data stream (e.g. low level tasks). The upper layers of the software stack have to be processed by main CPU 606 (shown as a dual core comprising 606a and 606b). This requires data load operations from shared memory e.g. DDR SDRAM 612 into L1D$ 614a, 614b of CPU 606. Toolchains may differ between the main CPU and engine 616, as both have typically a different instruction set. Moreover, a standard acceleration engine such as engine 616 generally requires some communication between CPU 606 and the engine, at least at the initial stage classifying a new data flow. Furthermore, the data exchange between engine 616 and CPU 606 is typically performed via shared memory, such as shared buffer 612.

FIG. 6c shows an aspect of the disclosure based on implementation of a coprocessor 618. A coprocessor is an advanced scheme to process data flows. Data 602 is steamed in and out of coprocessor 618, while CPU 606(a,b) processes the data. Applying standard acceleration engine 616 within coprocessor 618 may reduce communication overhead, because main CPU 606 controls the hardware accelerator blocks. Also a standard toolchain compiler can be used to build the software, which processes the accelerated data flow. There would therefore be no need to program a proprietary processing engine with its proprietary instruction set.

To the extent that data will be streamed through the coprocessor 618 but may not be available in the memory hierarchy of the coherent CPU cluster e.g. L1D$ and/or L2$, or even main memory, explicit load/store instructions may be provided to extract data from the stream and push it to shared memory e.g. DDR SDRAM 612.

Load balancing and synchronizing challenges that may arise due to CPU cores 606a and 606b connecting respectively to coprocessors 618a and 618b may be alleviated, for example by implementing a shared Coprocessor. Here each CPU controls a subset of hardware accelerators e.g. CPU 606a may control a first accelerator, such as a security accelerator, while CPU 606b may control a second accelerator, such as a routing accelerator. Furthermore, if the system, for example is not able to process the input data stream at wire speed, the stream cache takes care that always the next to be processed data, such as an Ethernet header, is immediately accessible by the Coprocessor.

FIG. 6d shows an aspect of the disclosure based on a semi-coherent acceleration engine. The idea of a semi-coherent accelerator engine (SCAE) is to place a standard acceleration engine to a coherence input-output (IO) port 622 of the coherent CPU system. Then, advantageously, the Standard Acceleration Engine learns the coherence protocol. This SCAE can now use the resources of the coherent CPU system e.g. store/load Ethernet header to/from the L2$, while the payload is stored in the main memory.

According to and aspect of the present disclosure, optionally, a stream cache unit 204 can be attached to the Engine and the coherence IO port, enabling the system to process input data stream at wire speed even with bursts.

FIG. 6e shows an aspect of the disclosure based on a cache-cohereint acceleration engine (CCAE). Received data 602 is filled into stream cache unit 204 and is therefore already in the coherent CPU cluster. Stream cache unit 204 provides that the next data to be processed, such as an Ethernet header, is immediately accessible by the Acceleration Engine as well as the CPUs 606a and 606b. In case the system may not be able to process input data stream 602 at wire speed, stream cache unit 204 pushes data temporarily to main memory. This push and pop operation is handled autonomously by the stream cache unit 204 fully transparent to the CPU 606 and Software. This idea can be extended further by attaching multiple CCAEs to the coherent CPU cluster. Data can be processed from any OCAE or CPU in a processing chain without any data copy operation. In order to keep the complexity low, the number of CCAEs and CPUs in a coherent system can be limited. Instead multiple coherent systems are connected via a coherent interconnect like Network on Chip, transporting the coherence information.

While aspects of the disclosure have been particularly shown and described, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A system, comprising:
a stream cache and a storage, wherein the stream cache includes:
a stream cache controller adapted to control transmission of input data through the stream cache; and
a stream cache memory, the stream cache memory being adapted:
to store at least first portions of the input data, as determined by the stream cache controller, and
to further output the stored first portions of the input data to a processor; and
wherein the storage is adapted:
to receive and store second portions of the input data, as determined by the stream cache controller, and
to further transmit the stored second portions of the input data for output to the processor.

2. The system according to claim 1, wherein the storage is adapted to further transmit the stored second portions to the stream cache memory.

3. The system according to claim 1, wherein the input data is received wirelessly.

4. The system according to claim 1, wherein the system is implemented in at least one of a WAN, DSL or PON system.

5. The system according to claim 1, wherein the system conforms at least in part to the G.hn standard.

6. The system as claimed in claim 1, wherein transmission of the stored second portions is to the stream cache memory for output to the processor.

7. The system according to claim 1, further comprising an input buffer from which the stream cache is adapted to receive the input data.

8. The system according to claim 1, wherein the stream cache controller is adapted to control the transmission of the input data through the stream cache by mediating the input data through the stream cache based on formatting of the input data.

9. The system according to claim 1, wherein the stream cache controller is adapted to mediate the input data through the stream cache based on priority of a stream of the input data.

10. The system according to claim 1, wherein the stream cache controller is adapted to control the transmission of the input data through the stream cache by mediating the input data through the stream cache based on pointers of the portions of the input data stored on the stream cache memory.

11. The system according to claim 10, wherein the stream cache controller further determines to store the other portions of the input data on the storage.

12. The system according to claim 1, adapted for use with input data wherein the first portions of the input data stored on the stream cache memory are data packet headers and wherein the second portions of the input data stored on the storage are data packet bodies.

13. The system according to claim 7, further comprising a merger unit adapted to merge the data packet headers with the respective data packet bodies.

14. The system according to claim 1, adapted to store, on the stream cache memory, data packets included in the first portions of the input data on a first-in basis, and adapted to store, on the storage, data packets of the second portions of the input data.

15. The system according to claim 12, wherein the input data is data most recently received by the stream cache from an input buffer.

16. The system according to claim 1, wherein the storage is provided by a level-two cache.

17. The system according to claim 1, wherein the storage is provided by an external memory.

18. The system according to claim 1, wherein the storage is adapted to transmit the stored second portions of the input data to the stream cache memory on a first-in first-out basis at a time determined by the stream cache controller.

19. The system according to claim 18, wherein the storage is adapted to transmit the stored second portions of the input data to the stream cache memory on a first-in first-out basis based on formatting thereof as instructed by the stream cache controller.

20. A non-volatile computer-readable medium on which at least one instruction is stored that, when executed, cause at least one processor:
to determine first portions of an input data stream to be stored locally on a cache memory and second portions of the input data stream to be stored on a different storage;
to store pointers to the first portions of the input data stream that are stored locally on the cache memory; and
to fetch the second portions of the input data stream that are stored on the different storage based on a specified criterion.

21. The non-volatile computer-readable medium according to claim 20, wherein the at least one instruction, when executed, causes the at least one processor to determine to include at least one of:
determining to store data packets on the cache memory on a first-in basis and to store data packets on the different storage when the cache memory is at capacity;
determining to store first level priority data packets on the cache memory and to store second level priority data packets on the different storage;
fetching the second portions of the data stream that are stored on the different storage to the cache memory as the first portions of the input data stream stored on the cache memory are output to the data processing engine;
determining to store data packet headers on the cache memory and to store corresponding data packet bodies on the different storage; and
merging the data packet headers with the corresponding data packet bodies after the respective data packet headers have been processed by the data processing engine.

22. The non-volatile computer-readable medium according to claim 21, wherein the at least one instruction, when executed, causes the at least one processor to fetch or include fetching the second portions of the data stream that are stored on the different storage to the cache memory on a first-in first-out basis.

23. The non-volatile computer-readable medium according to claim 22, wherein the at least one instruction, when executed, causes the at least one processor to fetch from the different storage.
